(19) United States
(12) Patent Application Publication
(10) Pub. No.: US 2026/0101096 A1
(43) Pub. Date: Apr. 9, 2026

(54) ELECTRONIC APPARATUS AND CONTROL METHOD THEREOF

(71) Applicant: SAMSUNG ELECTRONICS CO., LTD., Suwon-si (KR)

(72) Inventors: Jeongrok JANG, Suwon-si (KR); Sangshin PARK, Suwon-si (KR)

(73) Assignee: SAMSUNG ELECTRONICS CO., LTD., Suwon-si (KR)

(21) Appl. No.: 19/406,317

(22) Filed: Dec. 2, 2025

Related U.S. Application Data
(63) Continuation of application No. PCT/KR2025/015785, filed on Oct. 2, 2025.

(30) Foreign Application Priority Data
Oct. 2, 2024 (KR) 10-2024-0133657

(51) Int. Cl. H04N 21/84; G10L 15/22

(52) U.S. Cl. CPC H04N 21/84; G10L 15/22

(57) ABSTRACT

Disclosed are an artificial intelligence (AI) system using a machine learning algorithm and an application thereof, and provided are an electronic apparatus and a control method thereof. The electronic apparatus includes a communication interface, memory storing instructions, and at least one processor. The instructions, when executed by the at least one processor collectively or individually, cause the electronic apparatus to identify an artificial intelligence model corresponding to a current screen among a plurality of artificial intelligence models based on a type of the current screen, which is identified by using information in association with contents, to acquire a prompt for acquiring description information corresponding to the current screen by using the information in association with contents, and to provide first description information corresponding to the prompt, acquired by transmitting the prompt to a server corresponding to the identified artificial intelligence model.

### CROSS-REFERENCE TO RELATED APPLICATIONS

This application is a continuation of International Application No. PCT/KR2025/015785 designating the United States, filed on October 2, 2025, in the Korean Intellectual Property Receiving Office and claiming priority to Korean Patent Application No. 10-2024-0133657, filed on October 2, 2024, in the Korean Intellectual Property Office, the disclosures of each of which are incorporated by reference herein in their entireties.

### BACKGROUND

### Field

[1] This disclosure relates to an electronic apparatus and a control method thereof, and particularly, to an electronic apparatus for providing description information on a currently displayed screen, and a control method thereof.

### Description of Related Art

[2] Artificial intelligence systems are computer systems that implement human-level intelligence and gain learning and make a decision on their own, and as they are used more often, secure a better recognition rate.

[3] AI technologies are comprised of machine learning (deep learning) technologies using an algorithm that enables an artificial intelligence model itself to classify and learn features of input data, and element technologies that enables an AI model to mimic the functions of the human brain such as a cognitive function, a decision-making function and the like by using a machine learning algorithm.

[4] The element technologies, for example, may include at least one of a language understanding technology of recognizing languages/letters of humans, a visual understanding technology of recognizing an object like the vision sense of humans, an inference/prediction technology of making a logical inference and prediction by determining information, a knowledge expression technology of processing experience information of humans as knowledge data, and a motion control technology of controlling autonomous driving of a vehicle and movement of a robot.

[5] In recent years, services such as description of a current screen have been provided with the advancement in various image recognition technologies. Conventionally, a method of providing description information of contents provided by content providers, and a method of providing description information based on image captioning have been used.

[6] However, in the conventional methods, description information on a current screen merely includes general description of a current screen. That is, in terms of the conventional methods, there is a problem that description information on a current screen does not include detailed information (e.g., the name of the character, a specific place, and the like) on the subject of the current screen.

[7] Meanwhile, the above-descried particulars may be provided as related art aiming for a better understanding of the present disclosure. Any argument or determination is not raised as to whether any of the particulars is applicable as prior art associated with the present disclosure.

### SUMMARY

[8] An electronic apparatus according to one embodiment includes a communication interface, memory storing instructions, and at least one processor, and the instructions, when executed by the at least one processor collectively or individually, cause the electronic apparatus to identify an artificial intelligence model corresponding to a current screen among a plurality of artificial intelligence models based on a type of the current screen, which is identified by using information in association with contents, to acquire a prompt for acquiring description information corresponding to the current screen by using the information in association with contents, and to provide first description information corresponding to the prompt, acquired by transmitting the prompt to a server corresponding to the identified artificial intelligence model.

[9] The instructions, when executed by the at least one processor collectively or individually, may cause the electronic apparatus to acquire information in association with a figure included in the current screen, image captioning information on the current screen, and information on a text included in the current screen by using the current screen captured while the contents are provided, to acquire text information corresponding to a voice output from the current screen through automatic speech recognition (ASR), and to acquire metadata in association with the contents.

The instructions, when executed by the at least one processor collectively or individually, may cause the electronic apparatus to acquire second description information on the current screen based on the information in association with a figure included in the current screen, the image captioning information on the current screen, the information on a text included in the current screen, the text information corresponding to a voice, and the metadata.

The instructions, when executed by the at least one processor collectively or individually, may cause the electronic apparatus to acquire first type information on the current screen by using information on a content type included in the metadata, to acquire second type information on the current screen by using content description information and a knowledge graph included in the metadata, to acquire third type information on the current screen by using the second description information and the knowledge graph, and to acquire type information on the current screen based on the first to third type information.

The instructions, when executed by the at least one processor collectively or individually, may cause the electronic apparatus to acquire the third type information through a plurality of screens, based on a number of the plurality of screens through which the third type information is acquired being greater than or equal to a threshold value, to identify a type of the current screen based on the third type information, and based on a number of the plurality of screens through which the third type information is acquired being less than a threshold value, to identify a type of the current screen based on the first type information and the second type information.

The instructions, when executed by the at least one processor collectively or individually, may cause the electronic apparatus to acquire the prompt by using the captured screen, the voice output form the current screen, the metadata and the second description information.

The instructions, when executed by the at least one processor collectively or individually, may cause the electronic apparatus to transmit the prompt and the second description information to the server and acquire the first description information from a server corresponding to the identified artificial intelligence model.

The instructions, when executed by the at least one processor collectively or individually, may cause the electronic apparatus to update weights of pieces of information for acquiring the second description based on the first description information received.

The instructions, when executed by the at least one processor collectively or individually, may cause the electronic apparatus to first provide the second description

information acquired by the electronic apparatus, and based on receiving the first description information, to remove the second description and provide the first description information.

Meanwhile, a control method of an electronic apparatus according to one embodiment includes identifying an artificial intelligence model corresponding to a current screen among a plurality of artificial intelligence models based on a type of the current screen, which is identified by using information in association with contents, acquiring a prompt for acquiring description information corresponding to the current screen by using the information in association with contents, and providing first description information corresponding to the prompt, acquired by transmitting the prompt to a server corresponding to the identified artificial intelligence model.

Providing the information in association with contents may include acquiring information in association with a figure included in the current screen, image captioning information on the current screen, and information on a text included in the current screen by using the current screen captured while the contents are provided, acquiring text information corresponding to a voice output from the current screen through automatic speech recognition (ASR), and acquiring metadata in association with the contents.

The method may further include acquiring second description information on the current screen based on the information in association with a figure included in the current screen, the image captioning information on the current screen, the information on a text included in the current screen, the text information corresponding to a voice, and the metadata.

The identifying the artificial intelligence model may include acquiring first type information on the current screen by using information on a content type included in the metadata, acquiring second type information on the current screen by using content description information and a knowledge graph included in the metadata, acquiring third type information on the current screen by using the second description information and the knowledge graph, and acquiring type information on the current screen based on the first to third type information.

The acquiring the third type information through a plurality of screens and the acquiring type information on the current screen may include, based on a number of the plurality of screens through which the third type information is acquired being greater than or equal to a threshold value, identifying a type of the current screen based on the third type information, and based on a number of the plurality of screens through which the third type information is acquired being less than a threshold value, identifying a type of the current screen based on the first type information and the second type information.

The acquiring a prompt may include acquiring the prompt by using the captured screen, the voice output form the current screen, the metadata and the second description information.

The acquiring the first description information may include transmitting the prompt and the second description information to the server and acquiring the first description information from a server corresponding to the identified artificial intelligence model.

The method may further include updating weights of pieces of information for acquiring the second description based on the first description information received.

The method may further include first providing the second description information acquired by the electronic apparatus, and the providing the second description information may include, based on receiving the first description information, removing the second description and providing the first description information.

In accordance with the present disclosure, an electronic apparatus may include: a communication interface; a memory that stores instructions; and at least one processor configured to, collectively or individually, execute the stored instructions to: based on information associated with content provided by a current screen, identify a type of the content, identify a large language model (LLM) among a plurality of LLMs that corresponds to the identified type of the content based on a comparison of a type of training data on which the LLM is trained to the identified type of the content, and acquire a prompt configured to acquire description information that corresponds to the content, and based on a transmission of the acquired prompt to a server corresponding to the identified LLM among the plurality of LLMs, acquire the description information that corresponds to the content, and provide the acquired description information.

The at least one processor may be further configured to, collectively or individually, execute the stored instructions to: based on a screen capture of the content provided on the current screen, acquire information associated with a figure of the content, acquire information associated with image captioning of the content, acquire information associated with text of the content, acquire text information corresponding to a voice output of the content through automatic speech recognition (ASR), and acquire metadata associated with the content.

The description information may be first description information, and the at least one processor may be further configured to, collectively or individually, execute the stored instructions to: based on the acquired information associated with the figure, the acquired

information associated with image captioning, the acquired information associated with the text, the acquired text information corresponding to the voice output, and the acquired metadata, acquire second description information that corresponds to the content.

The at least one processor may be further configured to, collectively or individually, execute the stored instructions to: based on information of a content type included in the acquired metadata, acquire first type information of the content, based on content description information and a knowledge graph included in the acquired metadata, acquire second type information of the content, based on the acquired second description information and the knowledge graph, acquire third type information of the content, and based on the acquired first type information, the acquired second type information, and the acquired third type information, acquire type information of the content.

The at least one processor may be further configured to, collectively or individually, execute the stored instructions to: acquire the third type information through acquisition of information from content provided by a plurality of screens, based on a number of the plurality of screens through which the third type information is acquired being greater than or equal to a threshold value, identify a type of content provided by the plurality of screens based on the acquired third type information, and based on a number of the plurality of screens through which the third type information is acquired being less than a threshold value, identify the type of content provided by the plurality of screens based on the first type information and the second type information.

### BRIEF DESCRIPTION OF THE DRAWINGS

FIG. 1 is a view illustrating a system for providing description information, according to one embodiment;

FIG. 2 is a block diagram illustrating a configuration of an electronic apparatus, according to one embodiment;

FIG. 3 is a view illustrating a plurality of modules for providing description information, according to one embodiment;

FIG. 4 is a sequence chart provided to explain a method of providing description information by an electronic apparatus and a server, according to one embodiment;

FIG. 5 is a view provided to explain information in association with contents, according to one embodiment;

FIG. 6A is a view provided to explain second description information, according to one embodiment;

FIG. 6B is a view provided to explain first description information, according to one embodiment; and

FIG. 7 is a flowchart provided to explain a control method of an electronic apparatus for providing description information, according to one embodiment.

### DETAILED DESCRIPTION

Embodiments of the present disclosure may be modified in various different forms, and may vary. Accordingly, specific embodiments are illustrated in the drawings, and described in detail in the detailed description. However, it is to be understood that the scope of the disclosure is not limited to the specific ones, and embodiments of the disclosure are to be understood as including various modifications, equivalents and/or alternatives of the embodiments set forth herein. In the drawings, like reference numerals may be used to indicate like elements.

In describing the disclosure, in case specific descriptions of known functions or configurations to which the disclosure pertains make the gist of the disclosure unnecessarily vague, detailed descriptions thereof are omitted.

Additionally, the embodiments described hereafter may be modified in various different forms, and it is to be understood that the scope of the technical spirit of the disclosure is not limited to the embodiments. Rather, the embodiments are provided to make the disclosure thorough and complete and to fully convey the technical spirit of the disclosure to those skilled in the art.

Terms set forth herein are merely used to describe a specific embodiment, and are not intended to limit the scope of the right that seeks protection. Unless explicitly stated otherwise, singular forms include plural forms as well.

In the disclosure, expressions such as “have,” “may have,” “include,” or “may include,” and the like are used to indicate the presence of a corresponding feature (e.g., elements such as a numerical value, a function, an operation, or a component and the like), and do not imply exclusion of the presence of additional features.

In the disclosure, expressions such as “A or B,” “at least one of A or/and B,” or “one or more of A or/and B” and the like may include all possible combinations of items listed together. For example, “A or B,” “at least one of A and B,” or “at least one of A or B” may refer to all cases including (1) at least one A, (2) at least one B, or (3) both of at least one A and at least one B.

In the disclosure, the expression “1st”, “2nd”, "first”, or "second”, and the like may be used to refer to various elements regardless of their order and/or importance, and may be used merely to differentiate one element from another but not intended to limit the elements.

Based on one element (e.g., a first element) referred to as being “(operatively or communicatively) coupled with/to or connected with/to” another element (e.g., a second element), it is to be understood that one element may be connected to another element directly or through yet another element (e.g., a third element).

On the other hand, based on one element (e.g., a first element) referred to as being “directly coupled with/to” or “directly connected with/to” another element (e.g., a second element), it is to be understood that yet another element (e.g., a third element) is not present between one element and another element.

In the disclosure, the expression “configured to… (or set to)” used in the disclosure may be used interchangeably with, for example, “suitable for…,” “having the capacity to…,” “designed to…,” “adapted to…,” “made to…,” or “capable of…” depending on circumstances. The term “configured to… (or set to)” may not necessarily mean “specifically designed to…” in terms of hardware.

Rather, in a certain situation, the expression “a device configured to…” may mean “being capable of performing” by the device together with another device or other components. For example, the phrase “a processor configured (or set) to perform A, B and C” may mean an exclusive processor (e.g., an embedded processor) for performing the functions, or a generic-purpose processor (e.g., a CPU or an application processor) capable of performing the functions by executing one or more software programs stored in a memory device.

In relation to the embodiments, the term “module” or “unit” may perform at least one function or operation, and be implemented by hardware or software or by a combination of hardware and software. Additionally, a plurality of “modules” or a plurality of “units” may be integrated into at least one module and be implemented as at least one processor except for a “module” or a “unit” that needs to be implemented by specific hardware.

Meanwhile, various elements and regions in the drawings are schematically illustrated. Accordingly, the technical spirit of the disclosure is not limited by relative sizes or distances illustrated in the accompanying drawings.

Meanwhile, a “prompt” according to one embodiment may denote an input for starting to interact with an artificial intelligence model (e.g., a generative AI model). The prompt may be a text input or a voice input including one or more texts and/or one or more sentences. In one embodiment, the prompt may include a natural-language text. In the natural-language text, various types of information such as context, intent, tasks, constraints and the like that can be used by a generative AI model to generate a response to a user inquiry or to control an electronic apparatus 100 may be included. Meanwhile, the prompt may be replaced with and referred to as various expressions representing an identical/similar concept. The prompt, for example, may be replaced with expressions such as “input”, “user input”, “input phrase”, “user command”, “directive”, “starting sentence”, “task query”, “trigger sentence”, “message” and the like, but not limited thereto.

An artificial intelligence model according to an embodiment of the present disclosure may be a Large Language Model (LLM). Here, the LLM is a language model configured as an artificial neural network including a large number of parameters.. The LLM may be trained with significant amounts of unlabeled corpus texts, based on self-supervised learning or non-self-supervised learning. At this time, an LLM may not only have the ability to generate answers to user inquiries, but also include reasoning capabilities, as well as the ability to formulate and execute plans on its own. Meanwhile, the LLM may be referred to as various terms such as a large language model, an AI chatbot model and the like. In particular, the LLM according to one embodiment may be a model that is trained to acquire description information corresponding to a current screen by inputting a prompt.

Meanwhile, “description information” according to one embodiment may be information describing a currently displayed screen. In particular, the description information may include information on contents in association with a current screen, information on an object (e.g., a character) included in a current screen, information describing a current screen, web information in association with a current screen, advertisement information and the like.

Hereafter, embodiments according to the present disclosure are specifically described with reference to the accompanying drawings such that those skilled in the art to which the disclosure pertains may readily implement the embodiments.

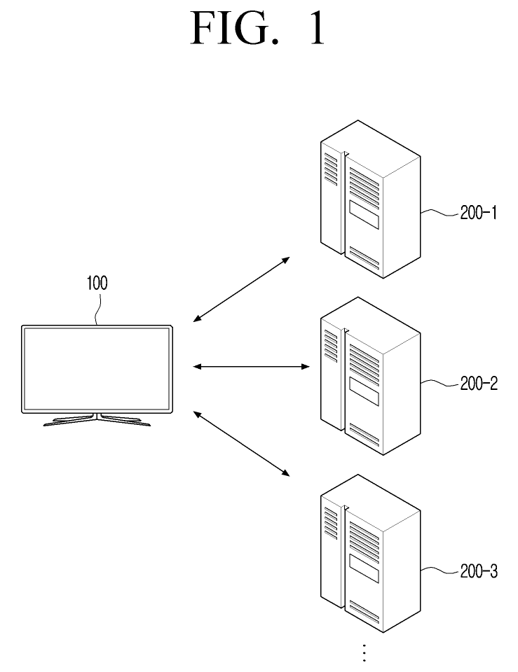

FIG. 1 is a view illustrating a system for providing description information, according to one embodiment. As illustrated in FIG. 1, the system for providing description information may include an electronic apparatus 100 and a plurality of servers 200-1, 200-2, 200-3 … . The electronic apparatus 100, as an apparatus for providing description information corresponding to contents and a current screen to the user, may be implemented as a TV, as illustrated in FIG. 1, but this is described merely as one embodiment, and the electronic apparatus 100 may be implemented as various apparatuses such as a set-top box, a desktop PC, a laptop, a projector, a refrigerator and the like. The plurality of servers 200-1, 200-2, 200-3 …, as a server for providing description information by using an LLM, may respectively store an LLM corresponding to a type of a current screen.

The electronic apparatus 100 may provide contents. Herein, the contents may be video contents such as broadcast contents, movie contents, sports contents and the like.

The electronic apparatus 100 may acquire information in association with contents. Herein, the information in association with contents may include information in association with a figure acquired through a current screen that is captured, image captioning information, and information on a text included in a current screen. Additionally, the information in association with contents may include text information corresponding to a voice output from a current screen and information included metadata.

The electronic apparatus 100 may identify a type of a current screen (or types of contents) by using the information in association with contents. In one embodiment, the electronic apparatus 100 may identify a type corresponding to a current screen among a sports type, a movie type, a drama type, a news type, a documentary type, an education type and a humor type by using the information in association with contents.

The electronic apparatus 100 may identify an LLM corresponding to a current screen among a plurality of LLMs based on the identified type of a current screen. That is, each of the plurality of LLMs may correspond to a type of a screen. For example, a first LLM, as an LLM corresponding to a sports type, may be a model that is trained to provide description information of a screen in association with sports, and a second LLM as an LLM corresponding to a movie type, may be a model that is trained to provide description information of a screen in association with a movie, and a third LLM, as an LLM corresponding to a drama type, may be a model that is trained to provide description information of a screen in association with a drama. Additionally, each of the plurality of LLMs may be stored in the plurality of servers 200-1, 200-2, 200-3 … illustrated in FIG. 1.

Further, the electronic apparatus 100 may acquire a prompt for inquiring description information corresponding to a current screen by using the information in association with contents. Herein, the electronic apparatus 100 may acquire initial description information (hereafter, “second description information") in advance by using the information in association with contents, in the electronic apparatus 100. Additionally, the electronic apparatus 100 may acquire a prompt based on the information in association with contents (e.g., a captured screen, a voice output from a current screen, metadata and the like) and the second description information.

The electronic apparatus 100 may transmit the acquired prompt to a server corresponding to the identified LLM among the plurality of servers 200-1, 200-2, 200-3 ... . At this time, the server to which the prompt is transmitted may be a server storing the LLM corresponding to a current screen, which is identified. Meanwhile, the embodiment of including the plurality of servers 200-1, 200-2, 200-3 … is described above but is described merely as one embodiment, and the server may be implemented as one server. In the case were the server is implemented as one server, the electronic apparatus 100 may transmit information on an LLM corresponding to a current screen together with a prompt such that the server may identify an LLM corresponding to a current screen, among the plurality of LLMs.

The server may acquire final description information (hereafter, “first description information”) on a current screen by inputting the prompt to the stored LLM. At this time, the final description information, as information more specific than the initial description information, may further include specific information (e.g., specific information on a character included in a current screen, specific information on a place displayed on a current screen and the like) compared to the initial description information.

The server may transmit the acquired first description information to the electronic apparatus 100.

The electronic apparatus 100 may provide the acquired first description information. Herein, the electronic apparatus 100 may provide the first description information on one area of a current screen. In one or more embodiments, the electronic apparatus 100 may provide the second description information first, and when receiving the first description information, remove the second description information and provide the first description information.

According to the embodiment described above, the electronic apparatus 100 may provide description information including various types of specific information rather than

scrappy description information, and accordingly, user experience of the user who uses the electronic apparatus 100 may improve.

Meanwhile, the embodiment of storing the plurality of LLMs in an external server is described above, but described merely as one embodiment, and certainly, the plurality of LLMs may be stored in the electronic apparatus 100.

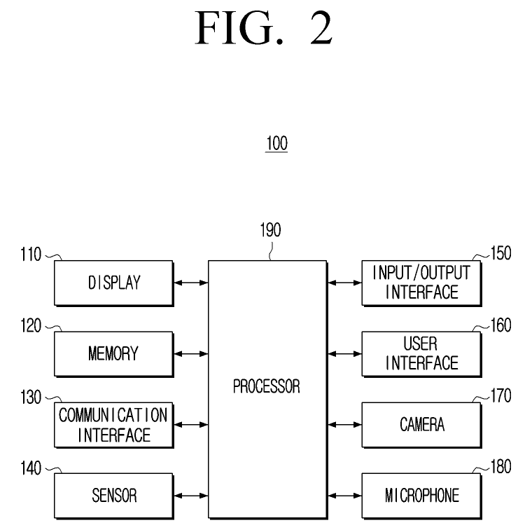

FIG. 2 is a block diagram illustrating a configuration of an electronic apparatus, according to one embodiment. As illustrated in FIG. 2, the electronic apparatus 100 may further include a display 110, memory 120, a communication interface 130, a sensor 140, an input/output interface 150, a user interface 160, a camera 170, a microphone 180 and a processor 190. However, this is described merely as one embodiment, and depending on a type of an electronic apparatus 100, some of the elements may certainly be removed or may be added. For example, in the case where the electronic apparatus 100 is implemented as a set-top box, the electronic apparatus 100 may not include the display 110.

The display 110 may include various types of display panels such as a liquid crystal display (LCD) panel, an organic light emitting diode (OLED) panel, an active-matrix organic light-emitting diode (AM-OLED), a liquid crystal on silicon (LcoS), a quantum dot light-emitting diode (QLED) and digital light processing (DLP), a plasma display panel (PDP), an inorganic LED panel, a micro LED panel and the like, but not limited thereto. Meanwhile, the display 110 may constitute a touch screen together with a touch panel, and may be comprised of a flexible panel.

In particular, the display 110 may display contents received from various sources (e.g., a communication interface 130, an input/output interface 150 and the like). Additionally, the display 110 may display description information corresponding to a current screen together with contents.

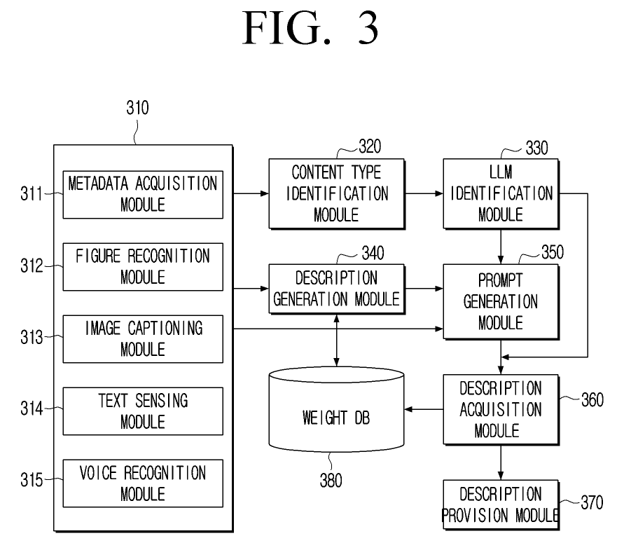

The memory 120 may store an operating system (OS) for controlling entire operations of the elements of the electronic apparatus 100, and store instructions or data in association with the elements of the electronic apparatus 100. In particular, the memory 120 may include various types of modules for providing description information corresponding to a current screen. In particular, in the case where an event for providing description information corresponding to a current screen occurs, the electronic apparatus 100, as illustrated in FIG. 3, may load, to volatile memory, data enabling various types of modules for providing description information corresponding to a current screen stored in non-volatile memory to perform various operations. Herein, the loading denotes calling and storing, into the volatile memory, data stored in the non-volatile memory such that the processor 190 may have access.

In one or more embodiments, the memory 120 may include a weight DB storing information on weights of pieces of information that is used at a time of generation of the second description information.

In one or more embodiments, the memory 120 may store at least one LLM.

Meanwhile, the memory 120 may be implemented as non-volatile memory (e.g., a hard disc, solid state drive (SSD), flash memory), volatile memory (may also include memory in the processor 190) and the like.

The communication interface 130 may include at least one circuit, and communicate with various types of external apparatuses or servers. In particular, according to one embodiment, the communication interface 130 may include a plurality of types of communication interfaces. For example, the communication interface 130 may include a Bluetooth communication interface, an IR communication interface, a WiFi communication interface and the like. In addition to the above-described communication interfaces, the communication interface 130 may certainly include various types of communication interfaces (e.g., a cellular communication module, a third-generation (3G) mobile communication module, a fourth-generation (4G) mobile communication module, a fourth-generation Long Term Evolution (LTE) communication module, a fifth-generation (5G) mobile communication module, an NFC communication module and the like).

In one or more embodiments, the communication interface 130 may transmit a prompt to an external server, and receive first description information on the prompt. Additionally, the communication interface 130 may transmit second description information together with the prompt.

The sensor 140 may sense a state (e.g., movement) of the electronic apparatus 100, or a state of an external environment (e.g., a user state), and generate an electrical signal or a data value corresponding to the sensed state. The sensor 140, for example, may include a gesture sensor, and an accelerometer.

The input/output interface 150 is an element for inputting and outputting at least one of audio and video signals. In one example, the input/output interface 150 may be a High Definition Multimedia Interface (HDMI) but this is described merely as one embodiment, and the input/output interface 150 may be any one of Mobile High-Definition Link (MHL), Universal Serial Bus (USB), Display Port (DP), Thunderbolt, a Video Graphics Array (VGA) port, an RGB port, D-subminiature (D-SUB), and a Digital Visual Interface (DVI). Depending on embodiments, the input/output interface 140 may separately include a port inputting and outputting an audio signal only and a port inputting and outputting a video signal only, or may be implemented as one port inputting and outputting both the audio signal and video signal.

In one or more embodiments, the input/output interface 150 may receive video contents from an external apparatus.

The user interface 160 may include a button, a lever, a switch, a touch-type interface and the like. At this time, the touch-type interface may be implemented in the way that an input is given on a display 110 screen of the electronic apparatus 100 based on a touch of the user.

In particular, the user interface 160 may receive various types of user instructions such as a user instruction for acquiring description information and the like.

The camera 170 may capture a still image and a moving image. The camera 170 according to various embodiments may include one or more lenses, an image sensor, an image signal processor, and a flash. The one or more lens may include a telephoto lens, a wide-angle lens and a super wide-angle lens that are disposed on the surface of the electronic apparatus 100, and may also include a three-dimensional (3D) depth lens. The camera 170 may be disposed on the surface (e.g., a rear surface or a front surface) of the electronic apparatus 100 but not limited to the above-described configuration, and various embodiments according to the disclosure may be implemented based on a connection with a camera 170 that is separately present outside the electronic apparatus 100.

The microphone 180 may denote a device that senses a sound and converts the sound into an electrical signal. For example, the microphone 180 may sense a voice in real time, and convert the sensed voice into an electrical signal such that the electronic apparatus 100 may perform an operation corresponding to the electrical signal. The microphone 180 may include a TTS module or an STT module.

The processor 190 may control the electronic apparatus 100 according to at least one instruction stored in the memory 120.

In particular, the processor 190 may include one or more processors. Specifically, the one or more processors may include one or more of a central processing unit (CPU), a graphics processing unit (GPU), an accelerated processing unit (APU), Many Integrated Core (MIC), a digital signal processor (DSP), a neural processing unit (NPU), a hardware accelerator or a machine learning accelerator. The one or more processors may

control one among other elements of the electronic apparatus or any combination thereof, and perform an operation in association with communication or data processing. The one or more processors may execute one or more programs or instructions stored in the memory. For example, the one or more processors may perform a method according to one embodiment, by executing one or more instructions stored in the memory.

In the case where the method according to one embodiment of the disclosure includes a plurality of operations, the plurality of operations may be performed by one processor, or by a plurality of processors. That is, when a first operation, a second operation, and a third operation are performed based on the method according to one embodiment, the first operation, the second operation and the third operation may all be performed by a first processor, or the first operation and the second operation may be performed by the first processor (e.g., a generic-purpose processor), while the third operation may be performed by a second processor (e.g., an AI-exclusive processor). For example, according to one embodiment, an operation of identifying a corner in a hand writing image or an operation of correcting a space in a handwriting image and the like by using a neural network model may be performed by a processor such as a GPU or an NPU that performs parallel computation, and an operation of generating/editing a planar image or a post-processing operation and the like may be performed by a generic-purpose processor such as a CPU.

The one or more processors may be implemented as a single core processor including one core, or one or more multicore processors including a plurality of cores (e.g., a homogeneous multi core or a heterogeneous multi core). In the case where the one or more processors are implemented as a multicore processor, each of the plurality of cores included in the multicore processor may include processor internal memory such as cache memory, and on-chip memory, and common cache shared by the plurality of cores may be included in the multicore processor. Additionally, each of the plurality of cores (or part of the plurality of cores) included in the multicore processor may read and perform a program instruction for implementing the method according to one embodiment independently or in the way that all (or part) of the plurality of cores are associated.

In the case where the method according to one embodiment includes a plurality of operations, the plurality of operations may be performed by one of the plurality of cores or performed by the plurality of cores included in the multicore processor. For example, when a first operation, a second operation, and a third operation are performed based on the method according to one embodiment, the first operation, the second operation and the third

operation may all be performed by a first core included in the multicore processor, or the first operation and the second operation may be performed by the first core included in the multicore processor, while the third operation may be performed by a second core included in the multicore processor.

In the embodiments of the disclosure, the processor 190 may denote a system on a chip (SoC) where one or more processors and other electronic components are integrated, a single core processor, a multicore processor, or a core included in a single core processor or a multicore processor, and herein, the core may be implemented as a CPU, a GPU, an APU, an MIC, a DSP, an NPU, a hardware accelerator, or a machine learning accelerator and the like, but embodiments thereof may not be limited thereto.

In particular, the processor 190 acquires information in association with contents while the contents are provided by executing at least one instruction stored in the memory 120, identifies a large language model (LLM) corresponding to a current screen among a plurality of LLMs based on a type of the current screen identified by using the information in association with contents, acquires a prompt for inquiring description information corresponding to the current screen by using the information in association with contents, acquires first description information corresponding to the prompt by transmitting the prompt to a server corresponding to the identified LLM, and provides the first description information.

In one or more embodiments, by executing at least one instruction stored in the memory 120, the processor 190 may capture the current screen while the contents are provided, acquire information in association with a figure included in the current screen, image captioning information on the current screen and information on a text included in the current screen by using the current screen captured, acquire text information corresponding to a voice output from the current screen based on automatic speech recognition (ASR), and acquire metadata in association with the contents.

In one or more embodiments, by executing at least one instruction stored in the memory 120, the processor 190 may acquire second description information on the current screen based on the information in association with a figure included in the current screen, the image captioning information on the current screen, the information on a text included in the current screen, the text information corresponding to a voice, and the metadata.

In one or more embodiments, by executing at least one instruction stored in the memory 120, the processor 190 may acquire first type information on the current screen by

using information on a content type included in the metadata, acquire second type information on the current screen by using content description information and a knowledge graph included in the metadata, acquire third type information on the current screen by using the second description information and the knowledge graph, and acquire type information on the current screen based on the first to third type information.

In one or more embodiments, by executing at least one instruction stored in the memory 120, the processor 190 may acquire third type information through a plurality of screens, based on a number of the plurality of screens through which the third type information is acquired being greater than or equal to a threshold value, identify a type of the current screen based on the third type information, and based on a number of the plurality of screens through which the third type information is acquired being less than a threshold value, identify a type of the current screen based on the first type information and the second type information.

In one or more embodiments, by executing at least one instruction stored in the memory 120, the processor 190 may acquire a prompt by using the captured screen, the voice output from the current screen, the metadata and the second description information.

In one or more embodiments, by executing at least one instruction stored in the memory 120, the processor 190 may transmit the prompt and the second description information to a server corresponding to the identified LLM and acquire the first description information from the server.

In one or more embodiments, by executing at least one instruction stored in the memory 120, the processor 190 may update weights of pieces of information for acquiring second description based on the first description information received.

In one or more embodiments, by executing at least one instruction stored in the memory 120, the processor 190 may provide the second description information acquired by the electronic apparatus 100 first, and when receiving the first description information, may remove the second description and provide the first description information.

FIG. 3 is a view illustrating a plurality of modules for providing description information, according to one embodiment. As illustrated in FIG. 3, the electronic apparatus 100 may include a content information acquisition module 310, a content type identification module 320, an LLM identification module 330, a description generation module 340, a prompt generation module 350, a description acquisition module 360, and a description provision module 370. Herein, the electronic apparatus 100 may further include a weight DB 380.

The content information acquisition module 310 may acquire information in association with contents. Specifically, the content information acquisition module 310 may acquire metadata on currently received contents, or capture a currently displayed screen or acquire a voice output from a current screen. Additionally, the content information acquisition module 310 may further acquire information in association with contents by using the metadata, the captured screen and the voice output from a current screen.

In one or more embodiments, the content information acquisition module 310 may capture and store a plurality of screens continuously or periodically. The content information acquisition module 310 may acquire information in association with contents concerning the plurality of screens stored.

Specifically, the content information acquisition module 310, as illustrated in FIG. 3, may include a metadata acquisition module 311, a figure recognition module 312, an image captioning module 313, a text sensing module 314, and a voice recognition module 315, to acquire information in association with various types of contents.

The metadata acquisition module 311 may acquire metadata that are provided together with contents through a content provider or a service provider. At this time, the metadata may include the titles, characters and genres of contents, content-related description and another information.

The figure recognition module 312 may recognize a figure from a current screen captured. In particular, the figure recognition module 312 may acquire information on a figure by using various types of machine learning models. Specifically, the figure recognition module 312 may extract an area including a figure in a current screen, and crop the extracted area by using an object sensing model. Additionally, the figure recognition module 312 may acquire information of a figure by inputting the extracted area to a figure recognition engine. Herein, the figure recognition engine may be stored in the electronic apparatus 100 but this is described merely as one embodiment, and the figure recognition engine may certainly be stored in an external server. At this time, the information on a figure may include information on the gender, height, name and appearance of a figure and the like.

The image captioning module 313 may acquire letters or phrases that describe a current screen captured by using image captioning. Image captioning is a technology for describing the content of an image in texts. The electronic apparatus 100 may analyze an image based on image captioning, and express the meaning or context of the image in a natural language. Specifically, the electronic apparatus 100 may classify an image through the image

captioning module 313, sense an object included in the image, and acquire information on the sensed object in a natural language. Accordingly, the electronic apparatus 100 may acquire image captioning information, as a text that describes a current screen through the image captioning module 313.

The text sensing module 314 may sense a text included in a current screen captured, and acquire information on the text. Herein, the text sensing module 314 may extract, in a text form, subtitle information that is configured in an image form in the current screen, through optical character recognition (OCR).

The voice recognition module 315 may acquire a text corresponding to a voice output to a current screen through the automatic speech recognition (ASR) technology. Specifically, the voice recognition module 315 may capture voice data output to a current screen, and acquire a text corresponding to a voice output through the ASR technology from the captured voice data.

The content type identification module 320 ma identify a content type based on the information in association with contents acquired from the content information acquisition module 310. In particular, the content type identification module 320 may identify a type corresponding to a current screen among a plurality of content types.

Specifically, the content type identification module 320 may identify a type corresponding to a current screen based on the information in association with a figure included in the current screen, the image captioning information on the current screen, the information on a text included in the current screen, the text information corresponding to a voice, and the metadata that are acquired from the content information acquisition module 310.

In one or more embodiments, the content type identification module 320 may acquire first type information on a current screen by using information on a content type included in the metadata. For example, in the case where a “movie” is included in the information on contents included in the metadata, the content type identification module 320 may identify a type corresponding to a current screen as a movie type.

In one or more embodiments, the content type identification module 320 may acquire second type information on a current screen by using content description information and a knowledge graph included in the metadata. Herein, the knowledge graph may be a data structure visually expressing a relationship between data, and mainly indicate objects (concepts, things, figures and the like) and a relationship therebetween by a node (an object) and an edge (a relationship). For example, in the case where the content description information included

in the metadata indicates that the story of this movie is … and that main characters are XXX and YYY, the content type identification module 320 may identify a type corresponding to a current screen as a movie type by using the knowledge graph.

In one or more embodiments, the content type identification module 320 may acquire third type information on a current screen by using second description information and a knowledge graph that are described hereafter. For example, in the case where generated second description information indicates that the pitcher standing on the mound is ready to throw the ball, the content type identification module 320 may identify a type corresponding to a current screen as a sports type by using the knowledge graph.

In particular, the content type identification module 320 may acquire third type information through a plurality of screens captured. Additionally, in the case where a number of the plurality of screens through which the third type information is acquired is greater than or equal to a threshold value, the content type identification module 320 may identify a type of a current screen based on the third type information. In the case where a number of the plurality of screens through which the third type information is acquired is less than a threshold value, the content type identification module 320 may identify a type of a current screen based on the first type information and the second type information.

In addition, the content type identification module 320 may identify a type corresponding to a current screen based on various types of texts (e.g., a text corresponding to a subtitle or a text corresponding to a voice and the like). In one example, in the case where a text included in a current screen indicates a baseball score, the content type identification module 320 may identify a type corresponding to the current screen as a sports type.

The LLM identification module 330 may identify one of a plurality of LLMs based on the type corresponding to a current screen, which is identified by the content type identification module 320. Specifically, the electronic apparatus 100 may store content types matching the plurality of LLMs. That is, each of the plurality of LLMs may be an LLM that is trained based on a content type. For example, a first LLM may be an LLM trained based on information on movie contents, and a second LLM may be an LLM trained based on information on sports contents. That is, the LLM identification module 330 may provide more accurate and professional description information on a current screen by identifying an LLM corresponding to the current screen among the plurality of LLMs.

The description generation module 340 may generate second description based on information in association with contents. Herein, the second description may be

description generated by the electronic apparatus 100, and distinguish from first description acquired by an LLM.

In particular, the description generation module 340 may generate second description based on image captioning information. Specifically, the description generation module 340 may acquire second description information by adding information on a figure appearing on a current screen, a text corresponding to a subtitle included in a current screen, a text corresponding to a voice output from a current screen, and content information included in the metadata to image captioning information acquired by the image captioning module 313.

In one or more embodiments, the description generation module 340 may generate second description based on weights stored in the weight DB 380. At this time, the weights may be weights of pieces of information used at a time of generation of second description. In particular, the weights stored in the weight DB 380 may be identical values in an initial stage. For example, in the case where information used at a time when second description is generated is first information on a figure appearing on a current screen, second information including a text corresponding to a subtitle included in a current screen, third information including a text corresponding to a voice output from a current screen and fourth information included in the metadata, weights of the first to fourth information may be 0.25 respectively in an initial stage. However, a weight of each information may be updated later by first description.

The prompt generation module 350 may generate a prompt for generating description. Herein, the prompt generation module 350 may generate a prompt by using the second description together with a captured screen, a voice output from a current screen, and metadata (e.g., title information, content description information, character information), in the information in association with contents.

In one embodiment, the prompt generation module 350 may generate a prompt for generating description by using a prompt templet previously stored. In another embodiment, the prompt generation module 350 may generate a prompt by inputting, to a trained neural network model, second description together with a captured screen, a voice output from a current screen, and metadata (e.g., title information, content description information, character information), in the information in association with contents.

The description acquisition module 360 may transmit the prompt acquired through the prompt generation module 350 to a server corresponding to an LLM identified by the LLM identification module 330. Herein, the server corresponding to an identified LLM

may acquire first description information on a current screen by inputting the prompt to the LLM. Herein, the first description information acquired may include information on a current screen, which is more specific than the second description information. As the server corresponding to the identified LLM acquires the first description information on a current screen, the description acquisition module 360 may receive the first description information on a current screen from the server.

Meanwhile, the embodiment of acquiring the first description information on a current screen by using an LLM stored in an external server is described above, but this is described merely as one embodiment, and the first description information on a current screen may be acquired by using an LLM stored in the electronic apparatus 100.

Additionally, the description acquisition module 360 may update a weight stored in the weight DB 380 based on the first description information on a current screen. In one or more embodiments, the description acquisition module 360 may update a weight corresponding to each of first information on a figure appearing on a current screen, second information including a text corresponding to a subtitle included in a current screen, third information including a text corresponding to a voice output from a current screen, and fourth information included in the metadata, based on the first description information on a current screen. For example, the description acquisition module 360 may update a weight such that a weight of image captioning information may be increased in the case where the image captioning information is used frequently when first description information on a current screen is generated.

The description provision module 370 may provide the first description information acquired by the description acquisition module 360. In one or more embodiments, the description provision module 370 may display the first description information together with currently replayed contents on the display 110. In one or more embodiments, the description provision module 370 may output the first description information through a speaker while the contents are currently displayed.

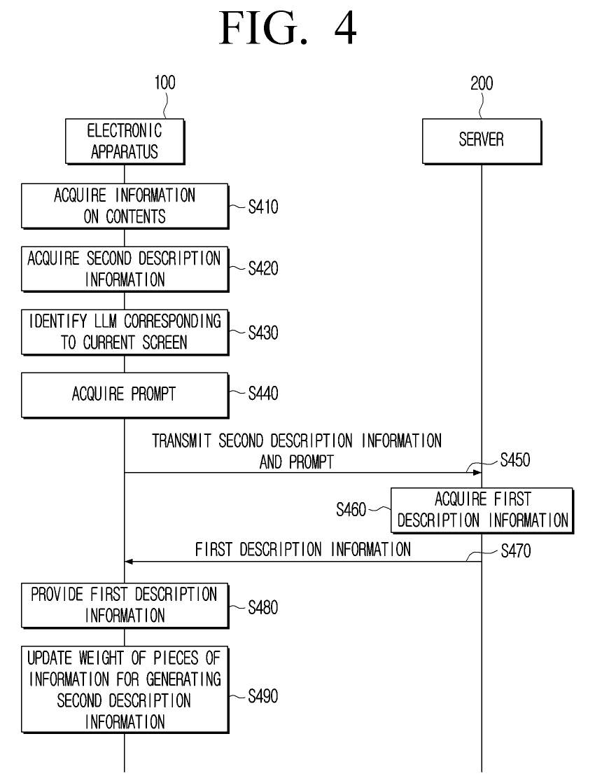

FIG. 4 is a sequence chart provided to explain a method of providing description information by an electronic apparatus and a server, according to one embodiment.

In the embodiments described hereafter, each of the operations may be performed sequentially, but not necessarily performed sequentially. For example, the order of each of the operations may be changed or at least two of the operations may be performed in parallel.

In one or more embodiments, it may be understood that S410 to S490 are performed by a processor (e.g., a processor 190 of FIG. 2) of an electronic apparatus (e.g., an electronic apparatus 100 of FIG. 1) or a server (e.g., an external server of FIG. 1).

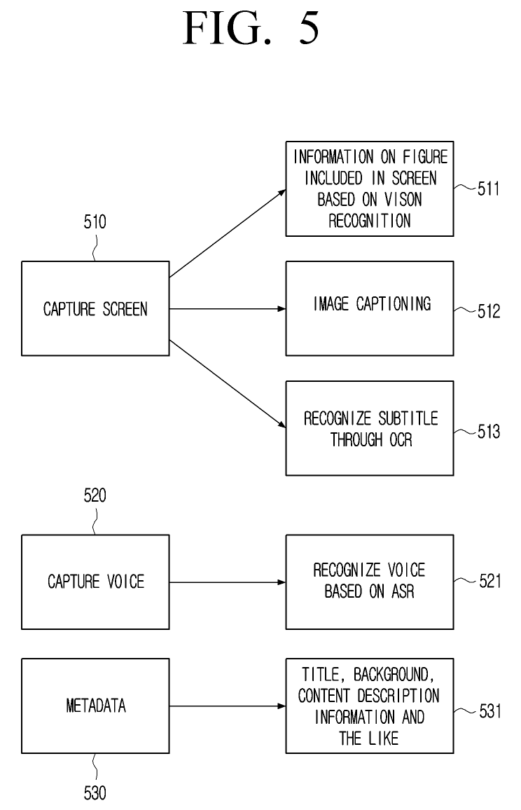

The electronic apparatus 100 may acquire information on contents (S410). Herein, the information on contents may be acquired through a captured screen, voice capture and metadata. Specifically, the electronic apparatus 100, as illustrated in FIG. 5, may acquire information 511 on a figure included in a screen, through screen capture 510, based on vision recognition. Additionally, the electronic apparatus 100 may acquire information on a current screen by performing image captioning 512 through the screen capture 510. Further, the electronic apparatus 100 may recognize 513 a subtitle by using OCR through the screen capture 510. Further, the electronic apparatus 100 may perform ASR-based voice recognition 521 through voice capture. Furthermore, the electronic apparatus 100 may acquire information 531 on contents such as a title, a background, content description information and the like based on metadata 530.

The electronic apparatus 100 may acquire second description information (S420). Specifically, the electronic apparatus 100 may acquire the second description based on information in association with contents. More specifically, the electronic apparatus 100 may acquire the second description information by adding, to image captioning information acquired by the image captioning module 313, information on a figure appearing on a current screen, a text corresponding to a subtitle included in a current screen, a text corresponding to a voice output from a current screen, and content information included in metadata.

The electronic apparatus 100 may identify an LLM corresponding to a current screen (S430). Specifically, the electronic apparatus 100 may identify a type of a current screen based on the information in association with contents. Additionally, the electronic apparatus 100 may identify an LLM corresponding to the type of a current screen among a plurality of LLMs.

The electronic apparatus 100 may acquire a prompt (S440). Specifically, the electronic apparatus 100 may acquire the prompt by using a captured screen, a voice output from a current screen, metadata and second description information.

The electronic apparatus 100 may transmit the second description information and the prompt to a server 200 (S450). Herein, the server 100 may be a server storing the LLM corresponding to a current screen.

The server 200 may acquire first description information (S460). Specifically, the server 200 may acquire the first description information by using the received second description information and prompt. In particular, the server 200 may acquire first description information on a current screen by inputting the acquired prompt to the LLM. Additionally, the server 200 may modify the first description information acquired based on the second description information.

The server 200 may transmit the acquired first description information to the electronic apparatus 100 (S470).

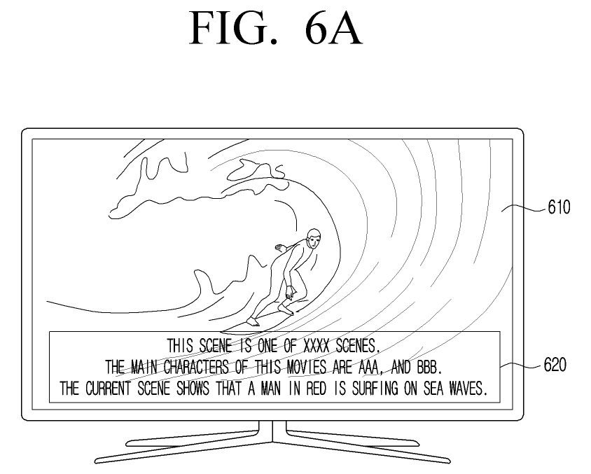

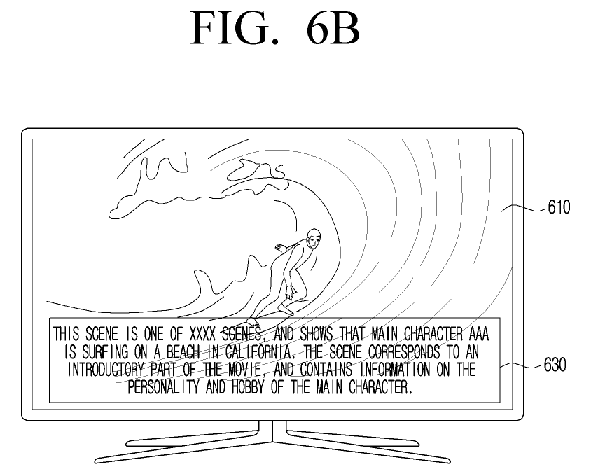

The electronic apparatus 100 may provide first description information 480 (S470). In one or more embodiments, the electronic apparatus 100, as illustrated in FIG. 6A, may provide second description information 620 on a current screen together with contents. Herein, when acquiring the second description information 620 in S420, the electronic apparatus 100 may provide the acquired second description information 620 first. Additionally, when receiving first description from the server 200, the electronic apparatus 100, as illustrated in FIG. 6B, may remove the second description information 620, and provide first description information 630 on a current screen together with contents 610. As illustrated in FIG. 6A and FIG. 6B, the first description information 630 may include information (e.g., detailed information on a figure included in a screen and detailed information on a current screen and the like) that is more specific than the second description information 620. Meanwhile, when receiving the first description information while a screen of FIG. 6A is displayed, the electronic apparatus 100 may provide a UI inquiring of the user whether to provide description information including specific information, and when receiving a user input through the UI, may transition the screen of FIG. 6A to a screen of FIG. 6B.

Further, the electronic apparatus 100 may provide the second description information to an application or a service user requiring description.

The electronic apparatus 100 may update weights of pieces of information for generating second description information (S490). Specifically, based on the first description information on a current screen, the electronic apparatus 100 may update a weight corresponding to each of first information on a figure appearing on a current screen, second information including a text corresponding to a subtitle included in a current screen, third information including a text corresponding to a voice output from a current screen, and fourth information included in metadata.

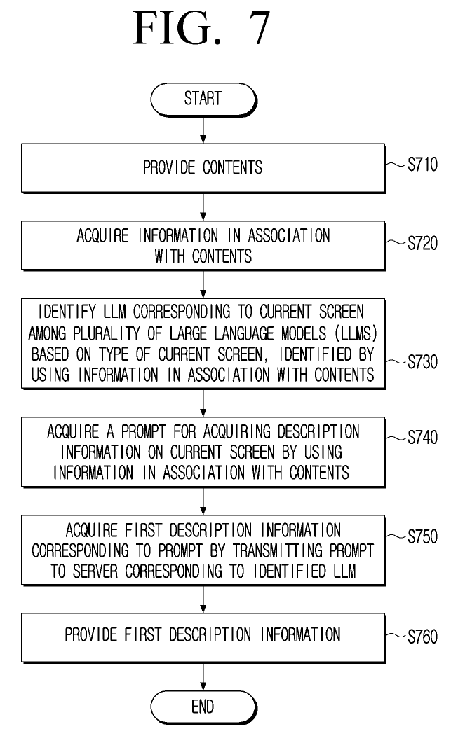

FIG. 7 is a flowchart provided to explain a control method of an electronic apparatus for providing description information, according to one embodiment.

In the embodiments described hereafter, each of the operations may be performed sequentially, but not necessarily performed sequentially. For example, the order of each of the operations may be changed or at least two of the operations may be performed in parallel.

In one or more embodiments, it may be understood that S710 to S760 are performed by a processor (e.g., a processor 190 of FIG. 2) of an electronic apparatus (e.g., an electronic apparatus 100 of FIG. 1).

First, an electronic apparatus 100 provides contents (S710).

The electronic apparatus 100 acquires information in association with contents (S720). In one or more embodiments, the electronic apparatus 100 may capture a current screen while contents are provided. Additionally, by using the current screen captured, the electronic apparatus 100 may acquire information in association with a figure included in the current screen, image captioning information on the current screen, and information on a text included in the current screen. Further, the electronic apparatus 100 may acquire text information corresponding to a voice output from the current screen through automatic speech recognition (ASR). Furthermore, the electronic apparatus 100 may acquire metadata in association with the contents.

The electronic apparatus 100 identifies a large language model (LLM) corresponding to a current screen among a plurality of LLMs based on a type of a current screen, which is identified by using the information in association with contents (S730). In one or more embodiments, the electronic apparatus 100 may acquire second description information on a current screen based on information in association with a figure included in a current screen, image captioning information on a current screen, information on a text included in a current screen, a text information corresponding to a voice and metadata.

In one or more embodiments, the electronic apparatus 100 may acquire first type information on a current screen by using information on a content type included in the metadata. The electronic apparatus 100 may acquire second type information on a current screen by using content description information and a knowledge graph included in the metadata. The electronic apparatus 100 may acquire third type information on a current screen by using the second description information and the knowledge graph. Additionally, the electronic apparatus 100 may acquire type information on a current screen based on the first to

third type information. In particular, the electronic apparatus 100 may acquire the third type information through a plurality of screens, and in the case where a number of the plurality of screens through which the third type information is acquired is greater than or equal to a threshold value, may identify a type of a current screen based on the third type information. In the case where a number of the plurality of screens through which the third type information is acquired is less than a threshold value, the electronic apparatus 100 may identify a type of a current screen based on the first type information and the second type information.

The electronic apparatus 100 acquires a prompt for inquiring description information corresponding to a current screen by using the information in association with contents (S740). In one or more embodiments, the electronic apparatus 100 may acquire the prompt by using a captured screen, a voice output from a current screen, metadata, and second description information.

The electronic apparatus 100 provides first description information corresponding to the prompt by transmitting the prompt to a server corresponding to the identified LLM (S750). In one or more embodiments, the electronic apparatus 100 may acquire the first description information from the server by transmitting the prompt and the second description information to the server corresponding to the identified LLM.

In one or more embodiments, the electronic apparatus 100 may update weights of pieces of information for acquiring second description based on the first description information received.

The electronic apparatus 100 provides the first description information (S760). In one or more embodiments, the electronic apparatus 100 may first provide the second description information acquired by the electronic apparatus 100. When receiving the first description information, the electronic apparatus 100 may remove the second description and provide the first description information.

The method according to the embodiments set forth herein may be provided in a computer program product. The computer program product may be exchanged between a seller and a purchaser as a commodity. The computer program product may be distributed in the form of a machine-readable storage medium (e.g., compact disc read only memory (CD-ROM)), or distributed (e.g., downloaded or uploaded) online through an application store (e.g., Play StoreTM) or directly between two user devices (e.g., smartphones). In the case of online distribution, at least part of the computer program product (e.g., a downloadable app) may be

stored at least temporarily, or generated temporarily in a machine-readable storage medium such as a server of a manufacturer, a server of an application store, or memory of a relay server.

The method according to the embodiments may be implemented with software including instructions stored in a storage medium readable by a machine (e.g., a computer). The machine, as a device capable of calling the stored instructions from the storage media and operating according to the called instructions, may include an electronic apparatus (e.g., a TV) according to the disclosed embodiments.

Meanwhile, the machine-readable storage medium may be provided in the form of a non-transitory storage medium Herein, the “non-transitory storage medium” only means that the non-transitory storage medium is a tangible device and includes no signal (e.g., an electromagnetic wave), while the term does not distinguish semi-permanent storage and temporary storage of data in the storage medium. For example, the “non-transitory storage medium” may include a buffer in which data are temporarily stored.

When the instructions are executed by a processor, the processor may perform functions corresponding to the instructions directly or by using other elements under the control of the processor. The instructions may include a code generated or executed by a compiler or an interpreter.

While the example embodiments of the present disclosure are illustrated and described above, embodiments of the disclosure are not limited to the embodiments set forth herein, and certainly, various modifications thereof may be made by those skilled in the art to which the disclosure pertains, without departing from the scope the disclosure claimed in the section of claims, and should not be understood as separating from the technical spirit or prospect of the disclosure.

What is claimed is:

1. An electronic apparatus comprising:
a communication interface;
memory storing instructions; and
at least one processor, wherein the instructions, when executed by the at least one processor collectively or individually, cause the electronic apparatus to:
identify an artificial intelligence model corresponding to a current screen among a plurality of artificial intelligence models based on a type of the current screen, which is identified by using information in association with contents;
acquire a prompt for acquiring description information corresponding to the current screen by using the information in association with contents; and
provide first description information corresponding to the prompt, acquired by transmitting the prompt to a server corresponding to the identified artificial intelligence model.

2. The electronic apparatus as claimed in claim 1, wherein the instructions, when executed by the at least one processor collectively or individually, cause the electronic apparatus to:
acquire information in association with a figure included in the current screen, image captioning information on the current screen, and information on a text included in the current screen by using the current screen captured while the contents are provided;
acquire text information corresponding to a voice output from the current screen through automatic speech recognition (ASR); and
acquire metadata in association with the contents.

3. The electronic apparatus as claimed in claim 2, wherein the instructions, when executed by the at least one processor collectively or individually, cause the electronic apparatus to:
acquire second description information on the current screen based on the information in association with a figure included in the current screen, the image captioning information on the current screen, the information on a text included in the current screen, the text information corresponding to a voice, and the metadata.

4. The electronic apparatus as claimed in claim 3, wherein the instructions, when executed by the at least one processor collectively or individually, cause the electronic apparatus to:
acquire first type information on the current screen by using information on a content type included in the metadata;
acquire second type information on the current screen by using content description information and a knowledge graph included in the metadata;
acquire third type information on the current screen by using the second description information and the knowledge graph; and
acquire type information on the current screen based on the first to third type information.

5. The electronic apparatus as claimed in claim 3, wherein the instructions, when executed by the at least one processor collectively or individually, cause the electronic apparatus to:
acquire the third type information through a plurality of screens;
based on a number of the plurality of screens through which the third type information is acquired being greater than or equal to a threshold value, identify a type of the current screen based on the third type information; and
based on a number of the plurality of screens through which the third type information is acquired being less than a threshold value, identify a type of the current screen based on the first type information and the second type information.

6. The electronic apparatus as claimed in claim 3, wherein the instructions, when executed by the at least one processor collectively or individually, cause the electronic apparatus to:
acquire the prompt by using the captured screen, the voice output form the current screen, the metadata and the second description information.

7. The electronic apparatus as claimed in claim 6, wherein the instructions, when executed by the at least one processor collectively or individually, cause the electronic apparatus to:
transmit the prompt and the second description information to the server and acquire the first description information from a server corresponding to the identified artificial intelligence model

8. The electronic apparatus as claimed in claim 7, wherein the instructions, when executed by the at least one processor collectively or individually, cause the electronic apparatus to:
update weights of pieces of information for acquiring the second description based on the first description information received.

9. The electronic apparatus of claim 3, wherein the instructions, when executed by the at least one processor collectively or individually, cause the electronic apparatus to:
first provide the second description information acquired by the electronic apparatus; and
based on receiving the first description information, remove the second description and provide the first description information.

10. A control method of an electronic apparatus, the method comprising:
identifying an artificial intelligence model corresponding to a current screen among a plurality of artificial intelligence models based on a type of the current screen, which is identified by using information in association with contents;
acquiring a prompt for acquiring description information corresponding to the current screen by using the information in association with contents; and
providing first description information corresponding to the prompt, acquired by transmitting the prompt to a server corresponding to the identified artificial intelligence model.

11. The method as claimed in claim 10, the method comprising:
acquiring information in association with a figure included in the current screen, image captioning information on the current screen, and information on a text included in the current screen by using the current screen captured while the contents are provided;
acquiring text information corresponding to a voice output from the current screen through automatic speech recognition (ASR); and
acquiring metadata in association with the contents.

12. The method as claimed in claim 11, the method further comprising:
acquiring second description information on the current screen based on the information in association with a figure included in the current screen, the image captioning information on the current screen, the information on a text included in the current screen, the text information corresponding to a voice, and the metadata.

13. The method as claimed in claim 12, wherein the identifying the artificial intelligence model includes acquiring first type information on the current screen by using information on a content type included in the metadata,
acquiring second type information on the current screen by using content description information and a knowledge graph included in the metadata,
acquiring third type information on the current screen by using the second description information and the knowledge graph, and
acquiring type information on the current screen based on the first to third type information.

14. The method as claimed in claim 13, the method comprising:
acquiring the third type information through a plurality of screens,
wherein the acquiring type information on the current screen includes, based on a number of the plurality of screens through which the third type information is acquired being greater than or equal to a threshold value, identifying a type of the current screen based on the third type information, and
based on a number of the plurality of screens through which the third type information is acquired being less than a threshold value, identifying a type of the current screen based on the first type information and the second type information.

15. The method as claimed in claim 12, wherein the acquiring a prompt includes acquiring the prompt by using the captured screen, the voice output form the current screen, the metadata and the second description information.

16. An electronic apparatus comprising:
a communication interface;
a memory that stores instructions; and
at least one processor configured to, collectively or individually, execute the stored instructions to:
based on information associated with content provided by a current screen,
identify a type of the content,
identify a large language model (LLM) among a plurality of LLMs that corresponds to the identified type of the content based on a comparison of a type of training data on which the LLM is trained to the identified type of the content, and
acquire a prompt configured to acquire description information that corresponds to the content, and
based on a transmission of the acquired prompt to a server corresponding to the identified LLM among the plurality of LLMs,
acquire the description information that corresponds to the content, and
provide the acquired description information.

17. The electronic apparatus of claim 16, wherein
the at least one processor is further configured to, collectively or individually, execute the stored instructions to:
based on a screen capture of the content provided on the current screen,
acquire information associated with a figure of the content,
acquire information associated with image captioning of the content,
acquire information associated with text of the content,
acquire text information corresponding to a voice output of the content through automatic speech recognition (ASR), and
acquire metadata associated with the content.

18. The electronic apparatus of claim 17, wherein
the description information is first description information, and
the at least one processor is further configured to, collectively or individually, execute the stored instructions to:
based on the acquired information associated with the figure, the acquired information associated with image captioning, the acquired information associated with the text, the acquired text information corresponding to the voice output, and the acquired metadata,
acquire second description information that corresponds to the content.

19. The electronic apparatus of claim 18, wherein
the at least one processor is further configured to, collectively or individually, execute the stored instructions to:
based on information of a content type included in the acquired metadata, acquire first type information of the content,
based on content description information and a knowledge graph included in the acquired metadata, acquire second type information of the content,
based on the acquired second description information and the knowledge graph, acquire third type information of the content, and
based on the acquired first type information, the acquired second type information, and the acquired third type information, acquire type information of the content.

20. The electronic apparatus of claim 19, wherein
the at least one processor is further configured to, collectively or individually, execute the stored instructions to:
acquire the third type information through acquisition of information from content provided by a plurality of screens,
based on a number of the plurality of screens through which the third type information is acquired being greater than or equal to a threshold value, identify a type of content provided by the plurality of screens based on the acquired third type information, and
based on a number of the plurality of screens through which the third type information is acquired being less than a threshold value, identify the type of content provided by the plurality of screens based on the first type information and the second type information.
